(19) United States
(12) Patent Application Publication
(10) Pub. No.: US 2010/0112381 A1
(43) Pub. Date: May 6, 2010

(54) ELECTROCHEMICAL ACTUATOR

(75) Inventors: Charles M. CARLSTROM, JR., Saratoga Springs, NY (US); David H. LEACH, Torrington, CT (US)

Correspondence Address: HESLIN ROTHENBERG FARLEY & MESITI PC, 5 COLUMBIA CIRCLE, ALBANY, NY, 12203, US

(73) Assignee: MTI MICRO FUEL CELLS, INC., Albany, NY (US)

(21) Appl. No.: 12/261,628

(22) Filed: Oct. 30, 2008

(51) Int. Cl. H01M 8/00; H01M 8/02; H01M 8/04

(52) U.S. Cl. 429/13; 429/24; 429/26

(57) ABSTRACT

A heat switch system includes a first surface thermally coupled to at least a portion of an associated component requiring temperature control. A second surface is spaced by a gap relative to the first surface. A gas generator is coupled to a first chamber configured to hold a gas generated by the gas generator. The first chamber includes a diaphragm configured to be deformed in response to an increase in an amount of the gas in the first chamber. A deformation of the chamber in response to the increase in the amount of the gas in the first chamber causes movement of the first surface and/or the second surface such that the first surface and the second surface move toward each other to reduce the gap and heat is transferred from the first surface to the second surface.

### CROSS-REFERENCE TO RELATED APPLICATION

This application relates to U.S. patent application No. (to be assigned) (Attorney Docket No. 2137.018), filed on the same day as the present patent application, and titled “ELECTROCHEMICAL ACTUATOR”; and U.S. patent application No. (to be assigned) (Attorney Docket No. 2137.018B), filed on the same day as the present patent application, and titled “ELECTROCHEMICAL ACTUATOR” the contents of which are both incorporated herein by reference.

### FIELD OF THE INVENTION

This invention relates generally to actuators, and more particularly, to electrochemical actuator's and methods for providing actuation to mechanical systems.

### BACKGROUND OF THE INVENTION

There are many products and processes requiring very small actuators and valves such as portable devices and devices that have packaging limitations on size. One example industry is the consumer electronics industry and another is the medical industry. An example product in the electronics industry utilizing such small actuators and valves is a fuel cell system as described below.

Fuel cells are devices in which electrochemical reactions are used to generate electricity. A variety of materials may be suited for use as a fuel depending upon the nature of the fuel cell. Organic materials, such as methanol, are attractive fuel choices due to their high specific energy.

Direct oxidation fuel cell systems may be suited for utilization in smaller mobile devices (e.g., mobile phones, handheld and laptop computers), as well as in some larger scale applications. In fuel cells of interest here, a carbonaceous liquid fuel in an aqueous solution (typically aqueous methanol) is applied to the anode face of a membrane electrode assembly (MEA). The MEA contains a layer of membrane electrolyte which may be a protonically conductive, but electronically non-conductive membrane (PCM or membrane electrolyte). Typically, a catalyst, which enables direct oxidation of the fuel on the anode aspect of the PCM, is disposed on the surface of the PCM (or is otherwise present in the anode chamber of the fuel cell). In the fuel oxidation process at the anode, the products are protons, electrons and carbon dioxide. Protons (from hydrogen in the fuel and water molecules involved in the anodic reaction) are separated from the electrons. The protons migrate through the PCM, which is impermeable to the electrons. The electrons travel through an external circuit, which includes the load, and are united with the protons and oxygen molecules in the cathodic reaction, thus providing electrical power from the fuel cell.

One example of a direct oxidation fuel cell system is a direct methanol fuel cell system or DMFC system. In a DMFC system, a mixture comprised predominantly of methanol and water is used as fuel (the “fuel mixture”), and oxygen, preferably from ambient air, is used as the oxidizing agent. The fundamental reactions are the anodic oxidation of the methanol and water in the fuel mixture into CO₂, protons, and electrons; and the cathodic combination of protons, electrons and oxygen into water.

Direct methanol fuel cells are being developed towards commercial production for use in portable electronic devices. Thus, the DMFC system, including the fuel cell and the other components should be fabricated using materials and processes that are compatible with appropriate form factors, and are cost effective in commercial manufacturing. Furthermore, the manufacturing process associated with a given system should not be prohibitive in terms of associated labor or manufacturing cost or difficulty.

Typical DMFC systems include a fuel source, fluid and effluent management and air management systems, and a direct oxidation fuel cell (“fuel cell”). The fuel cell typically consists of a housing, hardware for current collection and fuel and air distribution, and a membrane electrode assembly (“MEA”) disposed within the housing.

A typical MEA includes a centrally disposed, protonically conductive, electronically non-conductive membrane (“PCM”). One example of a commercially available PCM is NAFION® a registered trademark of E.I. Dupont de Nemours and Company, a cation exchange membrane comprised of polyperflourosulfonic acid, in a variety of thicknesses and equivalent weights. The PCM is typically coated on each face with an electrocatalyst such as platinum, or platinum/ruthenium mixtures or alloy particles. On either face of the catalyst coated PCM, the electrode assembly typically includes a diffusion layer. The diffusion layer on the anode side is employed to evenly distribute the liquid fuel mixture across the anode face of the PCM, while allowing the gaseous product of the reaction, typically carbon dioxide, to move away from the anode face of the PCM. In the case of the cathode side, a diffusion layer is used to achieve a fast supply and even distribution of gaseous oxygen across the cathode face of the PCM, while minimizing or eliminating the collection of liquid, typically water, on the cathode aspect of the PCM. Each of the anode and cathode diffusion layers also assist in the collection and conduction of electric current from the catalyzed PCM.

It is important that the fuel cells for use in powering the smaller mobile devices described above be as small as possible such that it is convenient to carry the devices incorporating the fuel cells. Thus, it is desirable for the components forming the fuel cell systems be as small as possible while still providing adequate power to the devices. For example, it is desirable that actuators providing mechanical action or motion within such fuel cell systems be as small as possible while still providing sufficient power to perform such mechanical action or motion. For example, actuators could be switches, valves, regulators or other components providing mechanical action or motion within a fuel cell system or other devices requiring such actuators. Actuators and valves (e.g., 1-way, 2-way, variable) that are commercially available are too large for applications on the scale appropriate for handheld devices. For example, MEMS actuators and valves are limited in how large they can be made thereby making them impractical for applications in the millimeter scale and above. Alternative actuator technologies such as electrostatic, shape memory alloys, piezoelectric (e.g., stacks and Bimorph, hydraulic) all have limitations either in force available, displacement or cost leaving a significant technology gap for actuators and valves in the above MEMs but below conventional technology size range.

Thus, a need exists for small actuators to produce force, pressure, or motion for products in size sensitive industries, such as consumer electronics and medical devices.

### SUMMARY OF THE INVENTION

The present invention provides, in a first aspect, a heat switch system which includes a first surface thermally coupled to at least a portion of an associated component requiring temperature control. A second surface is spaced by a gap relative to the first surface. A gas generator is coupled to a first chamber. The first chamber is configured to hold a gas generated by the gas generator. The first chamber includes a diaphragm configured to deform in response to an increase in an amount of the gas in the first chamber. A deformation of the diaphragm in response to the increase in the amount of the gas in the first chamber causes movement of the first surface and/or the second surface such that the first surface and the second surface move toward each other to reduce the gap, and possibly contact each other, and heat is transferred from the first surface to the second surface.

The present invention provides, in a second aspect, a method for controlling a temperature of a component which includes thermally coupling a component to a first surface. A second surface is spaced from the first surface by a gap. A gas is generated by a gas generator and receives the gas in the first chamber. An amount of the gas in the first chamber is increased to deform a diaphragm in the first chamber to cause movement of at least one of the first surface and the second surface such that the first surface and the second surface move toward each other to reduce the gap and possibly contact each other and heat is transferred from the first surface to the second surface.

The present invention provides, in a third aspect, a method for use in monitoring a state of an actuator which includes providing a membrane electrode assembly coupled to a source of electrical energy. The membrane electrode assembly includes a proton-exchange membrane disposed between a first electrode and a second electrode. A voltage is applied to the membrane electrode assembly to deplete a gas in a first chamber on a first side of the membrane into generated gas on an opposite side of a membrane into a second chamber. An amount of electrical current on the membrane is monitored. An amount of the gas in at least one of the first chamber and second chamber is determined based on the amount of the current.

### BRIEF DESCRIPTION OF THE DRAWINGS

The subject matter which is regarded as the invention is particularly pointed out and distinctly claimed in the claims at the conclusion of the specification. The foregoing and other objects, features, and advantages of the invention will be apparent from the following detailed description of preferred embodiments taken in conjunction with the accompanying drawings in which:

FIG. 1 is a side cross-sectional view of an electrochemical actuator system in accordance with the present invention;

FIG. 2 is a perspective cross-sectional view of a second electrochemical actuator system in accordance with the present invention;

FIG. 3 is an exploded perspective view of the actuator system of FIG. 2;

FIG. 4 is a side cross-sectional view of the actuator system of FIG. 2;

FIG. 5 is a perspective cross-sectional view of another electrochemical actuator system in accordance with the present invention;

FIG. 6 is an exploded perspective view of the actuator system of FIG. 5;

FIG. 6A is a side cross-sectional view of another embodiment of an electrochemical actuator system in accordance with the present invention;

FIG. 7 is a perspective cross-sectional view of a heat switch in accordance with the present invention;

FIG. 8 is a perspective cross-sectional view of another embodiment of a heat switch in accordance with the present invention;

FIG. 9 is perspective cross-sectional view of a valve system in accordance with the present invention;

FIG. 10 is an exploded perspective view of the valve system of FIG. 9; and

FIG. 11 is a schematic view of a O₂ pumping operation performed relative to the membrane electrode assembly of FIG. 1; and

FIG. 12 is a schematic view of a H₂ pumping operation performed relative to the membrane electrode assembly of FIG. 1.

### DETAILED DESCRIPTION OF AN ILLUSTRATIVE EMBODIMENT

In accordance with the principles of the present invention, electrochemical actuator systems for providing actuation force for valves, heat removal, pilot pressure source and restrictions are provided. Such systems are particularly useful in size sensitive actuation applications.

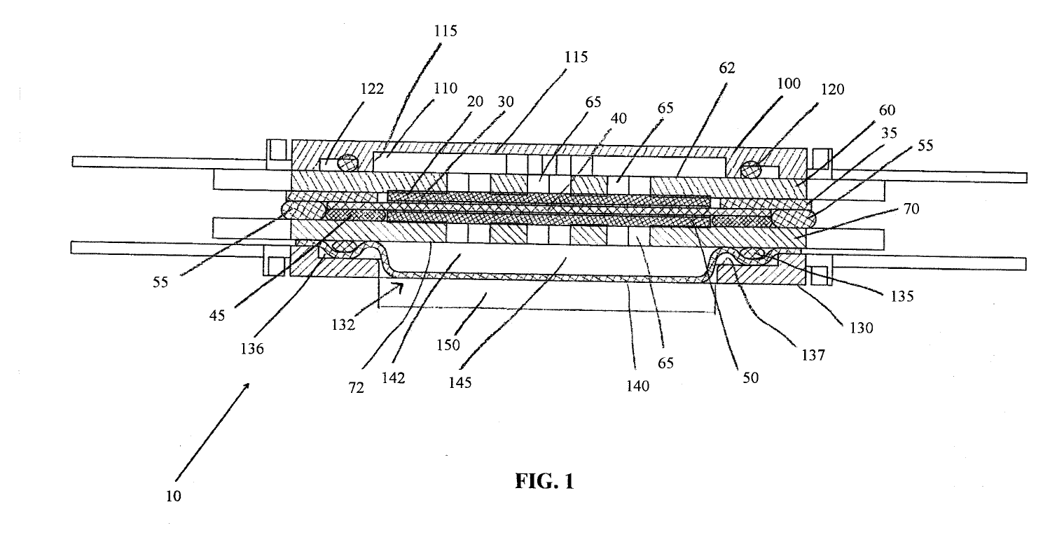

In an exemplary embodiment depicted in FIG. 1, an electrochemical actuator system 10 includes a membrane electrode assembly 20 having a protonically conductive (or proton-exchange) membrane 40 with catalyst coatings in intimate contact with its major surfaces and which is disposed between a first electrode, such as an anode side diffusion layer structure 30, and a second electrode, such as a cathode side diffusion layer structure 50. Protonically conductive membrane 40 is electronically non-conductive and, for example, may be formed of NAFION®, a registered trademark of E.I. Dupont de Nemours and Company, which is based on a polyperflourosulfonic acid and is available in a variety of thicknesses and equivalent weights. The membrane is typically coated on each of its major surfaces with an electrocatalyst such as platinum or a platinum/iridium mixture or alloyed particles (e.g., Pt, or PtIr, or PtIrOx). Alternatively, the electrocatalyst may be disposed on the anode side diffusion layer or the cathode side diffusion layer, and then placed in intimate contact with the protonically conductive membrane during the assembly process. One face of membrane 40 is an anode face or anode aspect, which abuts anode side diffusion layer structure 30. The opposing face of membrane 40 is on the cathode side and is herein referred to as the cathode face or the cathode aspect, which abuts cathode side diffusion layer structure 50, for example. The descriptions above of anode faces and aspects along with cathode faces and aspects refer to anodes and cathodes during a gas creation phase (e.g., during electrolysis).

Anode side diffusion layer structure 30 and cathode side diffusion layer structure 50 may be formed of materials known to those skilled in the art, including but not limited to carbon paper, carbon cloth, silicon, ceramics, metallic substances, and/or microporous plastics. The diffusion layer structures must be electrically conductive, and various additives or coatings may be added or applied to achieve desired properties. Anode side diffusion layer structure 30, cathode side diffusion layer structure 50, and membrane 40 may be bonded (e.g., laminated) together by applying heat and pressure to anode side diffusion layer structure 30 and/or cathode side diffusion layer structure 50 via heat pressing or heat rolling.

Membrane electrode assembly 20 may be received between a first current collector or compression plate 60 and a second current collector or compression plate 70. A first gas seal 35 (e.g., an O-ring) extends around a perimeter of anode side diffusion layer structure 30, is located between membrane 40 and first compression plate 60, and is configured to inhibit a movement of gas past seal 35 toward the surrounding ambient environment. A second gas seal 45 (e.g., an O-ring) extends around a perimeter of cathode side diffusion layer structure 50, is located between membrane 40 and second compression plate 70, and is configured to inhibit a movement of gas past seal 45 toward the surrounding ambient environment. A water seal 55 extends around a circumference of membrane 40 and is configured to inhibit movement of water past seal 55 toward the surrounding ambient environment. Also, first gas seal 35 may also inhibit movement of water toward the surrounding ambient environment such that the mating of first gas seal 35 and water seal 55 may provide a seal to inhibit movement of water toward the surrounding ambient environment. Further, first gas seal 35 could also be low in water permeability to inhibit the transfer of water past first gas seal 35. In a further example, water seal 55 and gas seal 35 could be replaced by a single seal which extends around a circumference of membrane 40 and between first compression plate 60 and second compression plate 70.

Returning to FIG. 1, water seal 55 inhibits drying of system 10 by inhibiting membrane 40 from being exposed to ambient conditions. Typically, in the prior art the edge of a membrane (e.g., membrane 40) in an electrochemical cell (e.g., a membrane electrode assembly sandwiched between two compression plates) would be sandwiched between two seals or gaskets to prevent gas leaks from either side of the membrane with an edge of the membrane extending outwardly beyond the seals. The membrane (e.g., formed of NAFION) often moves water very effectively therein such that it may move water from within the sealed portion of the cell (i.e., behind the seals holding the membrane) to an area of the membrane outside the seals and thereby exposed to the ambient environment if the partial pressure of water is less in the area beyond the membrane. Thus, in the prior art, the extension of a membrane past the seals of an electrochemical cell (e.g., a membrane electrode assembly sandwiched between two compression plates) allows the drying out of such cell by movement of water via the membrane from an interior portion of such a cell to an exterior portion thereof. Water seal 55 and gas seal 35 solve the problem of the transport of water via such a membrane to an exterior of an electrochemical cell by inhibiting movement of water and thereby maintaining a desired moisture or water level within system 10. For example, water will only migrate via membrane 40 to a cavity between second gas seal 45 and water seal 55 until the cavity has a partial pressure similar to the remainder of system 10. The water is thus maintained in system 10 for reuse in electrolysis as described below. For example, second gas seal 45 and water seal 55 may be two O-rings with an edge of a membrane lying in a cavity between the two O-rings. Further, second gas seal 45 and water seal 55 may be separate relative to each other, connected to each other or monolithically formed together. Also, second gas seal 45 and water seal 55 may be two sealing bumps on a single piece (i.e., monolithic) seal instead of being two separate seals.

First compression plate 60 and second compression plate 70 include passages 65 to allow gas generated by a gas generator, such as membrane electrode assembly 20, to pass therethrough. For example, such a gas may be generated by applying an electric current to the electrodes (e.g., first electrode 30 and second electrode 50) of the membrane electrode assembly to electrolyze water present on MEA 20 thereby forming hydrogen and oxygen gas on opposite sides of the membrane which may pass through passages 65 in each compression plate (i.e., compression plates 60 and 70). A cap plate 100 may be connected to, or monolithic relative to, compression plate 60 and may be an outermost portion of system 10. A gas storage cavity 110 may receive gas generated by the membrane electrode assembly (e.g., by electrolysis). Cavity 110 may be bounded and defined by interior surfaces 115 of plate 100 and an outside surface 62 of compression plate 60. A seal 120 (e.g., an O-ring) may be received in a cavity 122 of cap plate 100 and may inhibit movement of gas (e.g., hydrogen or oxygen) from cavity 110 toward the surrounding ambient environment.

Interior surfaces 137 of an actuation chamber plate 130 and an outside surface 72 of compression plate 70 may bound and define a gas storage chamber 142 receiving a diaphragm 140. An interior 145 of diaphragm may receive gas (e.g., hydrogen or oxygen) generated by membrane electrode assembly 20 (e.g., by electrolysis). A seal 135 (e.g., an O-ring) between diaphragm 140 and compression plate 70 held in a groove 136 of actuation chamber plate 130 may inhibit movement of gas (e.g., hydrogen or oxygen) and/or water toward the surrounding ambient environment. As described above, it is important to retain water within an electrochemical cell (e.g., MEA 20, compression plate 60, and compression plate 70) since such water is required for electrolysis and promotes conductivity on the membrane of the MEA. For example, loss of water in small electrochemical cells is one of the main failure modes thereof. It is also important to retain gases when such gases are stored in storage chambers. Preferably, diaphragm materials and seal material are low in O₂, H₂, and water permeability are utilized to prevent the loss of water and gases from an electrochemical cell.

Diaphragm 140 may be flexible and movable within gas storage chamber 142 in response to a change in an amount of gas in interior 145. Actuation chamber plate 130 may include an opening 132 through which diaphragm 140 may extend in response to increase in an amount of gas in interior 145, and the corresponding increase in pressure. The increase in pressure behind diaphragm 140 caused by the increase in the amount of gas in the interior may move the diaphragm and thereby an actuating member, such as a plunger 150, piston or other component for providing mechanical action or motion. Also, a decrease in the amount of gas, and the accompanying gas pressure, in interior 145 may cause diaphragm 140 to retract or move toward compression plate 70, e.g. through opening 132. Such a retraction of the diaphragm may be aided by a spring or other resilient member coupled to the diaphragm or an actuating member driven by the diaphragm. The diaphragm itself could also be resilient. For example, such a decrease in size of diaphragm 140 may be caused or allowed by a recombination of hydrogen from interior 145 and oxygen from gas storage chamber 110 to form water on membrane 40 by reverse electrolysis (i.e., by reversing the current flow direction). For example, the decrease in the amount of gases in interior 145 may decrease the size of the diaphragm to cause a retraction of plunger 150 driven by the diaphragm. Such a retraction of the plunger could also cause the plunger to be at least partially received within gas storage chamber 142.

As described above, applying a voltage to Membrane electrode assembly 20 saturated with water causes electrolysis to electrochemically convert water into H₂ gas and O₂ gas as depicted below:

### Net: Electrolysis & Recombination:

2H₂O(liquid) [symbol] O₂(gas)+2H₂(gas)

Thus, two 2 moles of liquid water produce 2 moles of H₂ and 1 mole of O₂ and there is a 3/2 molar ratio between the gases produced and the liquid water required. The O₂ and H₂ gas produced on either side of membrane 40 (e.g., a NAFION membrane) may be used to extend plungers (e.g., plunger 150), pistons or other actuating members to create motion (e.g., linear motion). Also, one of the gases may be utilized to create such motion while the other gas is expelled or stored for later recombination. The gases may be recombined to form water to remove pressure or retract the plungers, pistons or other actuating members. For example, at a constant pressure of 1 ATM, 1 cc of liquid water will produce 2050 cc of gas (683 cc O₂ & 1367 cc of H₂). The ratio of O₂ and H₂ produced from the liquid water is directly proportional to the current supplied to the membrane. Likewise, the rate of recombination of the gases back to water is also directly proportional to current across the membrane. Controlling current is therefore an easy and effective way to control the pressure, and amount of gas, in interior 145. Further, the relatively large gas volume to liquid volume ratio (e.g., 1 cc of liquid water will produce 2050 cc of gas) for the electrolysis process described above enables a system, such as system 10, utilizing such plungers, pistons or other actuating members driven by the changes in gas pressure to develop relatively large strains and pressures.

In order to repeatedly utilize an electrochemical actuator system, such as system 10, the process of electrolysis and reverse electrolysis must be repeatable. This requires that the proportions of hydrogen to oxygen produced during electrolysis be maintained in storage in proportion such that may they be recombined as desired to form water. However, in the case of leakage of oxygen or hydrogen from the chamber(s) (e.g., chamber 110 or chamber 142), it would not be possible to completely retract or otherwise disengage an actuating member (e.g., plunger 150) driven by a diaphragm (e.g., diaphragm 140), because enough of one of the elements (e.g., oxygen or hydrogen) may not be present to recombine the elements into water and thereby reduce the amount, and corresponding pressure, of each element in the chambers. For example, if H₂ gas permeated and leaked out of the appropriate storage chamber at a rate higher than the O₂ did from the other storage chamber, a recombination of the gases stored in the chambers back to water would result in a residual amount of O₂ left over thereby preventing a diaphragm (e.g., diaphragm 140) driving an actuating member from fully retracting. Further, in another example, permeation of inert gases into one or both of the chambers holding the gases could create a portion of inactive gas, which could also prevent the diaphragm from fully retracting due to its continued presence in the expandable diaphragm (e.g., diaphragm 140).

In an example, seal 120 between cap plate 100 and compression plate 60 may be configured to allow a gas (e.g., oxygen or hydrogen) to pass to the surrounding ambient environment when a particular pressure is reached in storage cavity 110 of cap plate 100. Because the proportion of gas in each of these chambers may deviate (e.g., by permeation) from the 1/2 ratio of O₂ to H₂ described above, the chamber(s) may be configured (e.g., using seal 120) to allow gas to escape when pressure therein reaches a predefined amount. By allowing a chamber, such as cavity 110, to leak above a typical working pressure, but prior to a mechanical failure of the chamber or the seal, the proper proportions of the gases may be restored. Water may be electrolyzed to provide gas to the respective storage chambers (e.g., storage chamber 110 and diaphragm 140 in chamber 142) for oxygen and hydrogen. For example, in the case of a hydrogen storage chamber lacking an appropriate amount of hydrogen for full combination with O₂ in an Oxygen storage chamber, O₂ and H₂ may be provided to the appropriate chambers by electrolysis. Some of the O₂ gas may leak past a seal (e.g., seal 120) in the Oxygen storage chamber (e.g., chamber 110) at pressures above a predefined leakage pressure while the H₂ gas would be retained in the appropriate chamber (e.g., chamber 142) as the excess O₂ gas is purged past the seal. The added flow (e.g., of O₂) or purging (e.g., past seal 120) may also purge out inert gases that may have migrated into the chamber (e.g., chamber 110).

Thus, the “overfilled” gas (e.g. oxygen) in the example described would leak past seal 120 when pressure in storage cavity 110 reached a leakage pressure thereby allowing hydrogen to continue to be generated such that the 1/2 desired ratio in the storage chambers may be recovered. Thus, the production of gases would eventually result in the desired ratio as O₂ and H₂ is continuously provided to the chambers and excess O₂ leaks out past the seal at the predefined pressure. The recovery of this ratio allows a diaphragm (e.g., diaphragm 140) and any actuating member driven thereby to be retracted to a start position because the gases may now be fully recombined into water. As depicted in FIG. 1, seal 120 could be an O-ring in groove 122 or it could be any other type of seal configured to inhibit movement of gas up to a particular pressure. Further, seal 135 could similarly provide a pressure relief function similar to that of seal 120.

For example, the chambers (e.g., chambers 110 and 142) of an electrochemical actuator system (e.g., system 10) may be sized exactly twice as large for H₂ storage as for O₂ storage and valves (not shown) or seals (e.g., seal 120) may be incorporated that enable both chambers to leak gas above 1000 PSI. The restoration of a desired gas balance (i.e., the 1/2 ratio described) could be performed at any time. If excess O₂ remained in an O₂ chamber (e.g., chamber 110), the O₂ chamber would leak sooner than an H₂ chamber (e.g., chamber 142) during a purge (i.e., via electrolysis), but such a purge would eventually cause each gas to leak past such valves or seals leaving 1000 PSI of each remaining in the appropriate chamber. Since the volume of the H₂ chamber would be twice the volume of the O₂ chamber, a perfect ratio would be provided to allow the recombination of the gases to form water and fully retract a diaphragm and driven actuating member. Although such a perfect ratio is theoretically possible, it is rarely needed so it is within the scope of this invention to restore a close ratio or ratio needed to obtain functional actuating members.

Further, such seals (e.g., seal 120) configured to leak at a desired pressure may also prevent damage to the storage chambers (e.g., chamber 110 or chamber 142) and system (e.g., system 10) as a whole. For example, if H₂ was used for actuation (i.e., driving a plunger, piston or other actuating member) and O₂ was stored and there was a continuous loss of H₂ due to diffusion or otherwise due to the operation of the system over the course of time, O₂ pressure would continually rise as an out of proportion amount of O₂ was supplied to the O₂ storage chamber until system 10 was mechanically damaged from the excessive pressure, absent a pressure relief mechanism, such as a seal (e.g., seal 120). Seal 120 (e.g., an O-ring) may thus be selected and installed such that it would leak beyond a certain leakage pressure (e.g., 1000 PSI), which would be prior to mechanical damage and higher than that required to contain the necessary gas(es) of recombination. The difference between the two pressures (i.e., a leakage pressure to allow gas to escape and a damaging pressure that would cause damage to the seal and/or system 10) is often many multiples apart.

An electrochemical cell (e.g., a membrane electrode assembly held between two compression plates) must be held under compression to manage the electrical losses between all of the interfacing layers in such a cell or cell assembly. The components that provide this compressive force are typically referred to as the cell clamping. The clamping required for an electrochemical actuator system (e.g., system 10) may be achieved by overmolding the system together as a unit or overmolding portions of the system (e.g., MEA 20, compression plate 60, and compression plate 70) together using plastic in an injection molding process. Conventionally, electrochemical cells have mechanical fasteners or other mechanical means to hold them in compression. By using injection molding over other clamping methods fewer parts are required and accommodations may be made relative to variations in cell component thickness. For example, system 10 may be compressed by a closing of a mold in an injection molding machine where it would have a layer of plastic applied to enough of an outside surface thereof to hold system 10 together under compression after the plastic applied has cured. In another example, the compression of system 10 in such an injection molding machine may be performed after the closing of a mold by a compression mechanism which causes the mold to compress system 10 via a threaded rod and adjustment nut or other mechanism providing such compression.

In a typical prior art electrochemical cell, a spring accommodates a relaxation of the membrane electrode assembly (MEA) to maintain the cell under compression. Absent such a spring, as the MEA relaxed there would be a significant fall off of cell compression leading to very high resistive losses. In one example, an electrochemical actuator system (e.g., system 10) is preloaded with a force to provide adequate sealing and compression of the MEA at the same time. A seal (e.g., seal 120) above a compression plate (e.g., compression plate 60) thereof provides resilience and acts as a spring would in the prior art device by maintaining the system under compression. As the MEA (e.g., MEA 20) relaxes, the seal (e.g., seal 120) expands due to the lessening of pressure thereon to maintain the pressure desired in the MEA. This is possible for small gas generation cells and actuation systems due to the very high linear gasket length of the seal (e.g., seal 120) relative the cell active area. Also, the sealing effectiveness of the seal (e.g., seal 120) would not be compromised because the deflection of the seal during compression is significantly more than the amount of relaxation of the MEA. For instance, if the seal deflected 0.010″ during compression and the MEA only relaxed 0.002″ over the life of the system (e.g., system 10) there would be very little effect on the seal effectiveness over the life of the cell.

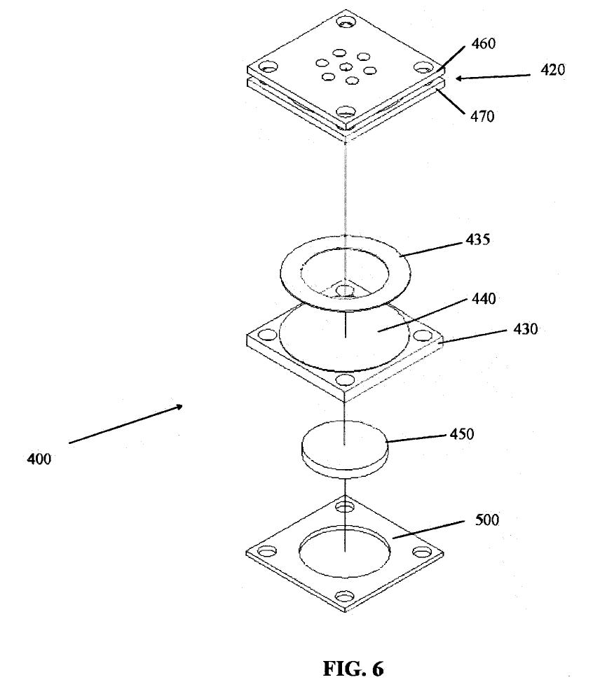

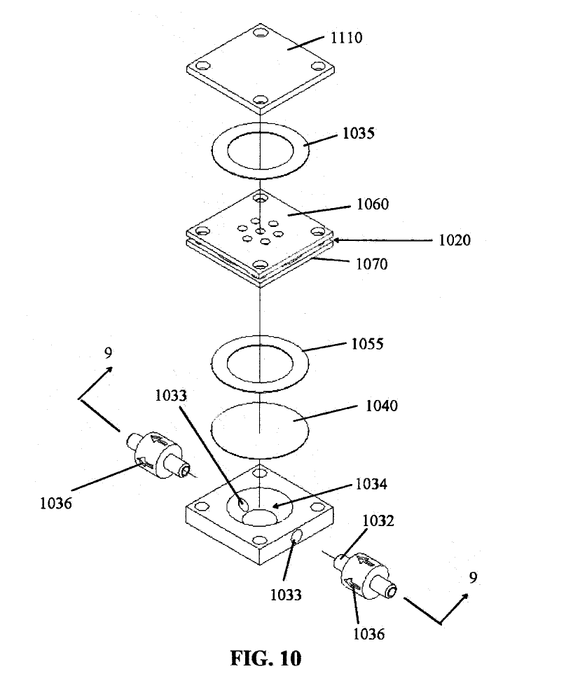

Also, to allow flexibility of design of electrochemical actuator systems, such as system 10, various gases can be used as a working fluid to drive a diaphragm (e.g., diaphragm 140). For example, H₂ and O₂ can be created by electrolyzing water as described above and one or both of the gases may drive the diaphragm while the other may be stored in a storage chamber. In a configuration shown in FIG. 6 one side of a cell is exposed to ambient air. In this configuration O₂ from the air is pumped across the membrane causing O₂ pressure behind the diaphragm. Such O₂ pumping is defined herein as the consumption of O₂ on one side of a membrane and a generation of O₂ on the other side of such a membrane as depicted in FIG. 11. For example, on a first side of a membrane open to the ambient air or a low pressure source of oxygen, oxygen may be combined with electrons and hydrogen ions to form water as depicted in the following formula:

O₂+4H⁺+4e [symbol] 2H₂O

On a second side of the membrane oxygen is generated via the following formula in which water is electrolyzed to form hydrogen ions and oxygen:

2H₂O [symbol] 4H⁺+4e+O₂

In this manner, O₂ from the air may be pumped across a membrane to cause O₂ pressure behind a diaphragm to actuate an actuating member or mechanical device, for example. Such O₂ pumping may occur at a voltage of about 0.5 to 1.3 volts, for example. H₂ may also be utilized to drive a diaphragm while oxygen may be stored in a storage chamber. H₂ or O₂ may be pumped back and forth across the membrane by itself without using a second gas by applying electrical energy (e.g., direct current) to the membrane electrode assembly.

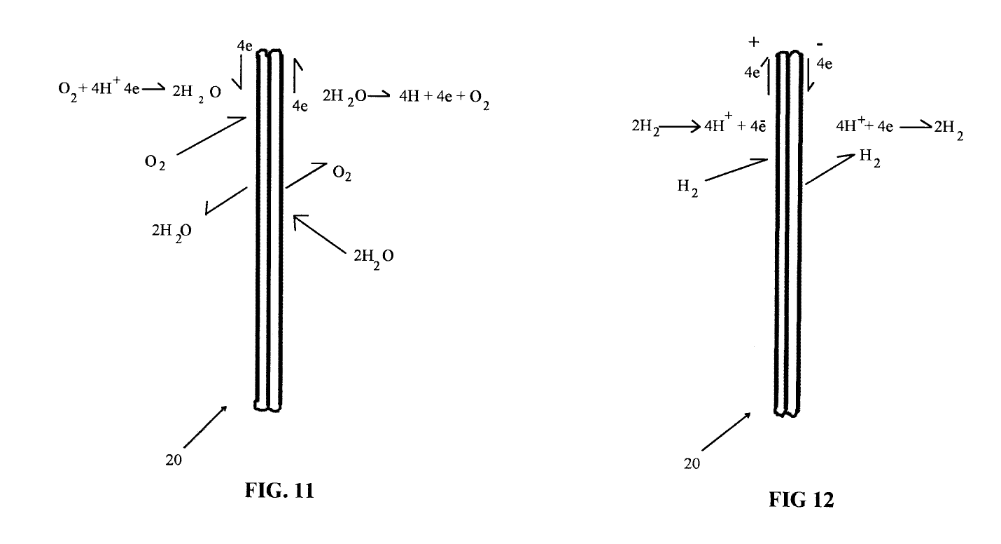

H₂ pumping as defined herein is depicted in FIG. 12 in which low pressure hydrogen is subjected to a voltage (e.g., 0.05-0.2 volts) to split the H₂ into hydrogen ions and electrons as depicted in the following formula:

2H₂ [symbol] 4H⁺+4e

On an opposite of the membrane, hydrogen ions and electrons are formed as hydrogen (e.g., under pressure) as described in the following formula:

4H⁺+4ē [symbol] 2H₂

As described above, permeation can cause the amount of gases held in storage chambers (e.g., chamber 110 or chamber 142) of electrochemical actuator systems (e.g., system 10) to be uncertain. Also, It may be difficult to know an amount of gas on a pumped/high pressure side of an electrochemical cell or system due to diffusion of gases across the membrane. It is desirable to know the state of an actuating member, such as the position of a diaphragm or actuating member driven thereby. It is also helpful to know when an active gas is depleted and the actuating member is fully retracted. Knowing this condition (i.e., the point at which a diaphragm and driven actuating member is fully retracted) would create a starting-over point after an unknown amount of diffusion occurred or after a long shutdown. A method of determining a point of full retraction of such a diaphragm or actuating member includes applying a voltage that would normally pump a gas (e.g., O₂ as described above) across a membrane and watching the fall-off of current via a current monitor (not shown). When the gas (e.g., O₂) that is being pumped is depleted the current will fade to a very low number. For example, if O₂ was used as a working fluid then a zero state of O₂ in an O₂ storage cavity may be found by applying 1.3 volts to pump the O₂ from the cavity until it is depleted. When the current approaches zero it is reasonable to assume that no O₂ remains in the cavity. The process may then be reversed and it would be possible to keep track of the O₂ quantity made by measuring the amount of electrical current per unit time (i.e., coulombs), via a current sensor (not shown). This method may be utilized to provide an estimate of the state of an actuating member prior to re-use thereof, or at any time to see how far off a calculated state of O₂ compares to the actual state of O₂. Also, these calibrations may be used to establish a regularly calibrated O₂ leak rate. In this way forecasts for a system (e.g., system 10) may be made on actual measurements. Although O₂ is described above as the working fluid, H₂ and H₂/O₂ may also be used in such a method with voltages different from that for O₂, for example.

As described above, a membrane (e.g., membrane 40) may allow water to move within an electrochemical actuator system (e.g., system 10). Water diffuses through the membrane allowing a water source to be on either side of a membrane electrode assembly (e.g., membrane electrode assembly 20). As described above, it is important to maintain the water within such a system (e.g., system 10) to prevent drying out of the membrane to ensure adequate conductivity and to allow sufficient water for electrolysis. Water is placed in a particular location at the start up of a system and when additional water is desired, e.g., on leakage of water from the system. Such water may be placed between a diaphragm (e.g., diaphragm 140) and a chamber receiving such diaphragm. For example, water may be received in interior 145 of diaphragm 140. As described, interior 145 may receive gas generated by membrane electrode assembly 20 and since interior 145 receives the gas from the membrane electrode assembly, there will be sufficient water available to create such gas via electrolysis. For example, as the amount of gas in interior 145 decreases during recombination (i.e., reverse electrolysis) process, the amount of water therein will increase with the water taking up less space than the gas which the water replaces.

As described above, it may be desirable to utilize oxygen as a working fluid in an electrochemical actuator system. However, it is not desirable to provide oxygen to electrochemical actuating member during assembly thereof such that only O₂ was held therein due to difficulties in providing the oxygen into a storage chamber of such a system during assembly or soon thereafter. However, such oxygen may be supplied to an electrochemical actuator system for use as a working fluid by creating both O₂ and H₂ using electrolysis and taking advantage of the fact that there is twice as much H₂ consumed during recombination (i.e., reverse electrolysis). In one example, two gas holding chambers for receiving gas generated by an MEA may be provided of equal size. Such chambers may both be configured to leak at a certain leak pressure. Water may be electrolyzed until both gases in the corresponding chambers reach the leak pressure. At the leak pressure, each full chamber would contain an equal amount of gas despite twice as much hydrogen being generated, i.e. the remainder of the hydrogen would leak out at the leak pressure. The electrical current may then be reversed to recombine the oxygen and hydrogen, but the H₂ will be fully consumed and only half of the O₂ would be used. The O₂ remaining may then be utilized as a working fluid, i.e. pumped back and forth across a membrane.

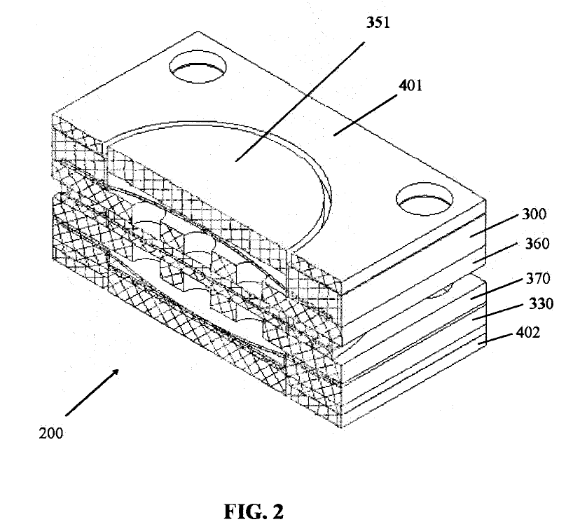

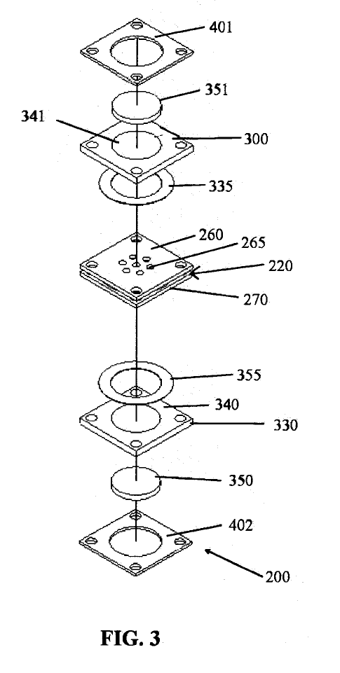

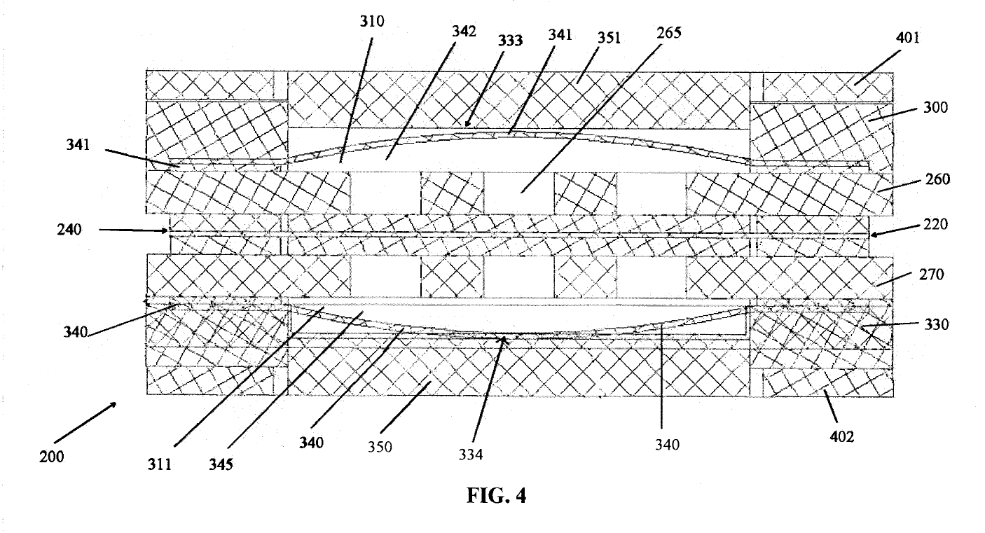

In another example, FIGS. 2-4 depict an electrochemical actuator system 200 similar to system 10 except that system 200 includes two oppositely disposed actuating members in contrast to plunger 150 and storage chamber 110 (FIG. 1). In particular, system 200 includes a membrane electrode assembly 220 having a protonically conductive membrane 240. Membrane electrode assembly 220 may be received between a first current collector or compression plate 260 and a second current collector or compression plate 270. First compression plate 260 and second compression plate 270 include passages 265 to allow gas generated by membrane electrode assembly 220 (e.g., via electrolysis) to pass therethrough. An actuation chamber plate 300 may be connected to compression plate 260. A gas storage chamber 342, similar to gas storage chamber 142, may be defined by interior surfaces of actuation chamber plate 300 and may receive gas generated by the membrane electrode assembly (e.g., by electrolysis) along with receiving a diaphragm 341. An interior 310 of diaphragm 341 similar to interior 145 may receive a gas (e.g., hydrogen or oxygen) generated by membrane electrode assembly 320 (e.g., by electrolysis). A seal 335 between diaphragm 341 and compression plate 360 may inhibit movement of gas (e.g., hydrogen or oxygen) and/or water toward the surrounding ambient environment. Diaphragm 341 may be flexible and movable in response to a change in an amount of gas in interior 310. Actuation chamber plate 300 may include an opening 333 through which diaphragm 341 may extend in response to increase in an amount of gas in the interior, and the corresponding increase in pressure. The increase in pressure behind diaphragm 341 caused by the increase in the amount of gas in the interior may move the diaphragm and thereby an actuating members, such as a plunger 350, piston or other actuating members. Also, a decrease in the amount of gas, and the accompanying gas pressure, in interior 310 may cause diaphragm 341 to retract or move toward compression plate 260, e.g. through opening 333. Plunger 351 may be held (e.g., provided circumferential or perimeter support) by a plunger support plate 401. Also, the plunger may extend into and out of gas storage chamber 342 as diaphragm 341 expands and retracts.

Similarly, an actuation chamber plate 330 may be connected to compression plate 270. A gas storage chamber 345, similar to gas storage chamber 142, may be defined by interior surfaces of actuation chamber plate 330 and may receive gas generated by the membrane electrode assembly (e.g., by electrolysis) along with receiving a diaphragm 340. An interior 311 of diaphragm 340, similar to interior 145, may receive gas (e.g., hydrogen or oxygen) generated by membrane electrode assembly 220 (e.g., by electrolysis). A seal 355 between diaphragm 340 and compression plate 370 may inhibit movement of gas (e.g., hydrogen or oxygen) and/or water toward the surrounding ambient environment. Diaphragm 340 may be flexible and movable in response to a change in an amount of gas in the interior thereof. Actuation chamber plate 330 may include an opening 334 through which diaphragm 340 may extend in response to increase in an amount of gas in interior 311, and the corresponding increase in pressure. The increase in pressure behind diaphragm 340 caused by the increase in the amount of gas in the interior may move the diaphragm and thereby an actuating members, such as a plunger 350, piston or other actuating members. Also, a decrease in the amount of gas, and the accompanying gas pressure, in the interior may cause diaphragm 340 to retract or move toward compression plate 270, e.g. through opening 334. Plunger 350 may be held (e.g., provided circumferential or perimeter support) by a plunger support plate 402. Also, plunger 350 may extend into and out of gas storage chamber 345 as diaphragm 340 extends and retracts.

Plunger 350 and plunger 351 may be moved in opposite directions in response to the amounts of gas provided by the MEA (e.g., via electrolysis) behind the diaphragms (i.e., diaphragm 340 and diaphragm 341) to drive the plungers (i.e., plunger 350 and plunger 351). The plungers may be used to provide linear motion, activate or deactivate switches or other mechanical action.

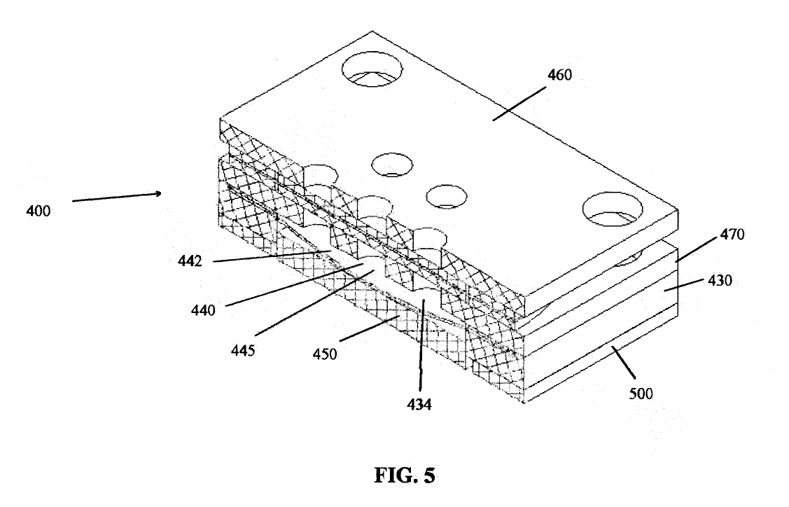

In another example depicted in FIGS. 5-6, an electrochemical actuator system 400 is similar to system 200 except that system 400 includes a diaphragm 440 and plunger 450 on a first side of a membrane electrode assembly 420 while on an opposite side of the membrane electrode assembly, system 400 is open to the surrounding ambient environment. An actuation chamber plate 430 may be connected to compression plate 470. A gas storage chamber 442, similar to gas storage chambers 142 and 342, may be defined by interior surfaces of actuation chamber plate 430 and may receive gas generated by the membrane electrode assembly (e.g., by electrolysis) along with receiving a diaphragm 440. An interior 445 of diaphragm 440, similar to interior 145, may receive gas (e.g., hydrogen or oxygen) generated by membrane electrode assembly 420 (e.g., by electrolysis). A seal 435 between diaphragm 440 and compression plate 470 may inhibit movement of gas (e.g., hydrogen or oxygen) and/or water toward the surrounding ambient environment. Diaphragm 440 may be flexible and movable in response to a change in an amount of gas in interior 445. Actuation chamber plate 430 may include an opening 434 through which diaphragm 340 may extend in response to increase in an amount of gas in interior 445, and the corresponding increase in pressure. The increase in pressure behind diaphragm 440 caused by the increase in the amount of gas in the interior may move the diaphragm and thereby an actuating members, such as a plunger 450, piston or other actuating members. Also, a decrease in the amount of gas, and the accompanying gas pressure, in the interior may cause diaphragm 440 to retract or move toward compression plate 470, e.g. through opening 434. Plunger 450 may be held (e.g., provided circumferential or perimeter support) by a plunger support plate 500. As indicated, the membrane electrode assembly may be open to the surrounding ambient environment via openings or passages 465 in compression plate 460 allowing oxygen to be drawn directly from the surrounding ambient environment for recombination of oxygen and hydrogen (e.g. stored in interior 445 and used as a working fluid to drive plunger 450). Upon electrolysis to provide hydrogen to interior 445, oxygen is expelled to the surrounding ambient environment from which it can be reclaimed when desired for recombination of the stored hydrogen and such oxygen into water on MEA 420. The use of the surrounding ambient environment as an oxygen source allows system 400 to be smaller than if the oxygen was stored in a storage chamber of system 400. Plunger 450 may be used to provide linear motion, activate or deactivate switches or other mechanical motion or force.

In another example depicted in FIG. 6A, an electrochemical actuator system 1300 is similar to electrochemical actuator system 10 (including identical reference numerals referring to identical parts) except that system 1300 includes a seal 1035 in groove 136 and located between diaphragm 140 and actuation chamber plate 130 instead being located between diaphragm 140 and compression plate 70 as is seal 135 (FIG. 1). Seal 1035 may inhibit movement of gas (e.g., hydrogen or oxygen) and/or water toward the surrounding ambient environment as does seal 135.

The location of seal 1035 on an opposite side of diaphragm 140 allows seal 1035 to the located away from, and avoid contact with, the working fluid (e.g., hydrogen, oxygen) and/or water located in storage chamber 142. As indicated above, diaphragm materials that are low in O₂, H₂, and water permeability are preferable. Also, the seals should be formed of material configured to retain the gases (e.g., hydrogen, oxygen) generated and/or water. The materials typically used for sealing are very elastic and may be high in permeability. As described, seal 1035 is placed on an opposite side of membrane 140 relative to storage chamber 142 and thus is outside the wetted area. Seal 1035 thus may retain a desired sealing function by having the seal press on the diaphragm from an opposite side thereof relative to seal 135. Such a location of the seal allows the diaphragm to make the actual seal eliminating exposure of the seal to the working fluids (e.g., oxygen, hydrogen and/or water). For such a seal (e.g., seal 1035) to be effective the seal must be relatively thick and compliant to make up for any surfaces that may be out of flatness. By placing the seal behind the diaphragm the seal still performs this needed function (i.e., making up for any surfaces out of flatness) but is not exposed to the working fluid(s). Further, utilizing the arrangement depicted in FIG. 6A, the material forming the diaphragm (e.g., diaphragm 140) may be optimized for its function free of the seal material requirements, such as compression stress relaxation, and the seal material can be optimized for its function free of the diaphragm requirements such as gas permeability and MEA material compatibility.

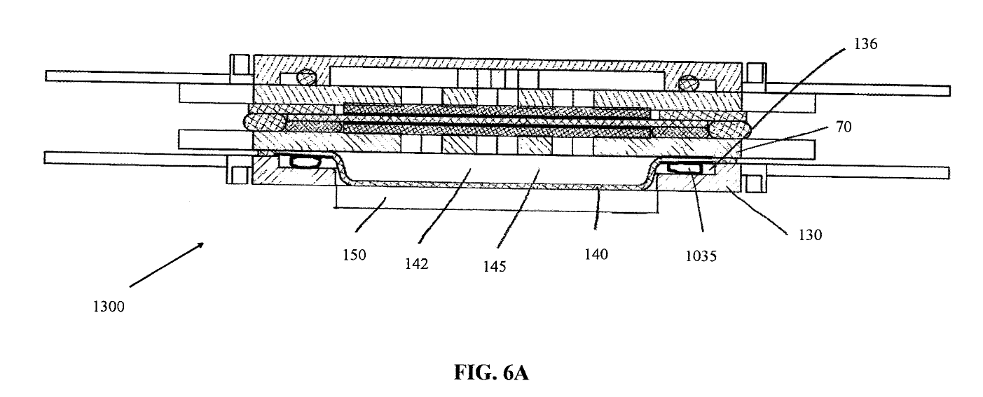

FIG. 7 depicts a heat switch system 600 similar to system 400 except that plunger 450 is replaced by a plunger 650 which drives a heat switch 655. An actuation chamber plate 630 may be connected to compression plate 670. A gas storage chamber 642, similar to gas storage chambers 142 and 342, may be defined by inner surfaces of actuation chamber plate 630 and may receive gas generated by a membrane electrode assembly 620 (e.g., by electrolysis or by O₂ pumping, i.e., extracting pure O₂ from air and forming O₂ on an opposite side of the membrane) along with receiving a diaphragm 640. An interior 645 of diaphragm 640 and storage chamber 642, similar to interior 145, may receive gas (e.g., hydrogen or oxygen) generated by membrane electrode assembly 620 (e.g., by electrolysis or O₂ pumping). A seal (not shown) between diaphragm 640 and compression plate 670 may inhibit movement of gas (e.g., hydrogen or oxygen) and/or water toward the surrounding ambient environment. Diaphragm 640 may be flexible and movable in response to a change in an amount of gas in interior 645. Actuation chamber plate 630 may include an opening 634 through which diaphragm 640 may extend in response to increase in an amount of gas in interior 645, and the corresponding increase in pressure. The movement of diaphragm 640 caused by the increase in the amount of gas in the interior may move plunger 650. Also, a decrease in the amount of gas, and the accompanying gas pressure, in the interior may cause diaphragm 640 to retract or move toward membrane electrode assembly 620, e.g. through opening 634. Plunger 650 may be held (e.g., provided circumferential or perimeter support) by a plunger support plate 700. Also, plunger 650 may extend through opening 634 in response to the extension or retraction of diaphragm 640. Compression plate 660 may be open to the surrounding ambient environment via passages 665 allowing oxygen to be drawn directly from the surrounding ambient environment for recombination of oxygen and hydrogen (e.g. stored in interior 645 and used as a working fluid to drive plunger 650). Upon electrolysis to provide hydrogen to interior 645, oxygen is expelled to the surrounding ambient environment from which it can be reclaimed when desired for recombination of the stored hydrogen and such oxygen into water on MEA 620. Also, as indicated above, O₂ can be electrochemically pumped across the cell from the ambient to create gas behind the diaphragm in interior 645.

In one example, direct oxidation fuel cells produce water, carbon dioxide and heat as a result of the reactions. This heat can be useful in terms of warming the fuel cell in a cold environment and ensuring that the reactions occur at a rate that is sufficient to generate sufficient power and current to provide power to the application device. However, in other operating circumstances, the heat can build up and result in dehydration of a membrane of such a fuel cell, which in turn results in a loss of efficiency and lower power output of the fuel cell. Thus, the heat generated in the reaction of such a fuel cell is preferably dissipated or transferred by heat switch 655.

More specifically, heat switch 655 contains a first (e.g., “hot”) heat transfer member 710 which, is thermally coupled to a component (e.g., of a fuel cell) requiring temperature control. A second (e.g., “cold”) heat transfer member 720 is placed at a desired distance or a gap 721 from first heat transfer member 710, and second heat transfer member 720 transfers heat to the ambient environment either directly or indirectly. For example, the second surface may be a portion of a casing or housing, or may be used to transfer heat to a casing or housing of an application device, a fuel cell system or other component. First heat transfer member 710 may include a heat transfer conduit 715 for receiving a heat transfer fluid and second heat transfer member 720 may include a second conduit 725 for receiving a heat transfer fluid. Such conduits may provide the excess heat (e.g. conduit 715) and the means (e.g., conduit 725) for expelling such excess heat, for example. A bottom contacting surface 723 of first heat transfer member 710 and a top contacting surface 724 of second heat transfer member 720 are separated by gap 721 provided that the temperature has not reached a particular threshold. Gap 721 may be maintained by a resilient member(s), such as a series of elastic beads or wave springs (not shown) therein. The gap is preferably on the order of about 250 microns, but it this will vary depending upon the particular application of the invention.

A sensor 711 may determine a temperature of first heat transfer member 710. In response to such temperature, as indicated above, plunger 650 may be driven (e.g., automatically by a controller (not shown) by diaphragm 640 in response to electrolysis of water on MEA 620. Plunger 650 may move bottom contacting surface 723 toward top contacting surface 724 (e.g., to contact) to reduce the thermally insulating air gap (i.e., gap 721) to increase heat transfer therebetween. For example, if first conduit 715 contains heat transfer fluid of excess temperature or otherwise has an elevated temperature, a contact between surface 723 and surface 724 may allow such excess heat to be transferred to second heat transfer member 720 and the heat transfer fluid in second conduit 725. Such heat may be expelled via the heat transfer fluid in second conduit 725 or directly by second heat transfer member 720. When the temperature of first heat transfer member 710 has decreased sufficiently (e.g., as determined by sensor 711), the electrolysis process may be reversed to recombine oxygen and hydrogen to form water on MEA 620 thereby retracting plunger 650 (e.g., with an assist from the wave springs) and moving first heat transfer member 710 away from second heat transfer member 720. For example, such reversal electrolysis may be caused by a controller (not shown) coupled to a temperature sensor (e.g., sensor 711). The thermally insulating air gap (i.e., gap 721) may be varied via a controller and the electrolysis and reverse electrolysis processes described above depending on how much heat transfer is desired between first heat transfer member 710 and second heat transfer member 720 and therefore how much distance is desired between first heat transfer member 710 and second heat transfer member 720, i.e., gap 721.

Also, in another example, system 600 may be identical to that depicted in FIG. 7 except that conduit 715 and conduit 725 may include heat conducting members connected to heat transfer members 710 and 720 instead of heat transfer fluids flowing through conduits in heat transfer members 710 and 720. For example, such heat conducting members may be metal rods which are connected on one end to such heat transfer members and which are immersed in a second end in a heat transfer fluid or a heat sink.

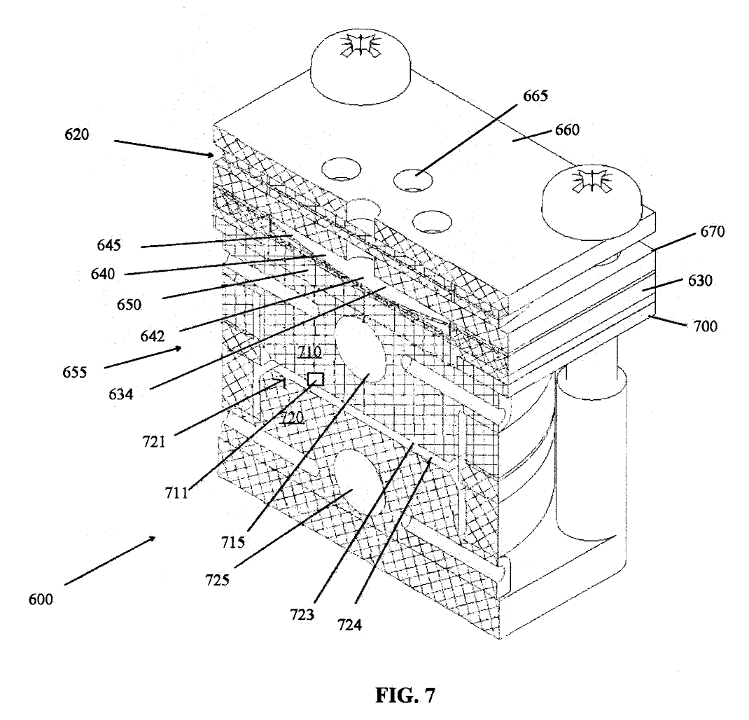

In another example depicted in FIG. 8, a heat switch system 700 is similar to system 600 (including identical numbering), except that system 700 and includes a cap plate 800 connected to compression plate 660 and may be the outermost portion of system 10. A gas storage cavity 810 may receive gas generated by the membrane electrode assembly (e.g., by electrolysis). Cavity 810 may be bounded and defined by interior surfaces (not shown and similar to interior surfaces 115) of plate 800 and outside surface (not shown and similar to outside surface 62) of compression plate 660. A seal (not shown and similar to seal 120) may be received in a cavity (not shown and similar to cavity 122) of cap plate 800 and may inhibit movement of gas (e.g., hydrogen or oxygen) from cavity 810 toward the surrounding ambient environment. Thus, in contrast to system 600, the gases generated by electrolysis are stored in cavity 810 (e.g., oxygen) and interior 645 (e.g., hydrogen). As described above, diaphragm 640 may extend in response to increase in an amount of gas (e.g., hydrogen) in interior 645, and the corresponding increase in pressure. Such electrolysis may be reversed to retract diaphragm 40 utilizing the gases in cavity 810 and interior 645.

As indicated above, the described and depicted heat switches may be utilized to cool or heat various components within a fuel cell, or other devices which would require cooling or heating and which small size and efficiency of the described heat switches is desired. For example, the heat switches described may be utilized in the applications described in co-owned U.S. patent application Ser. No. 11/021,971 relative to a different type of heat switch.

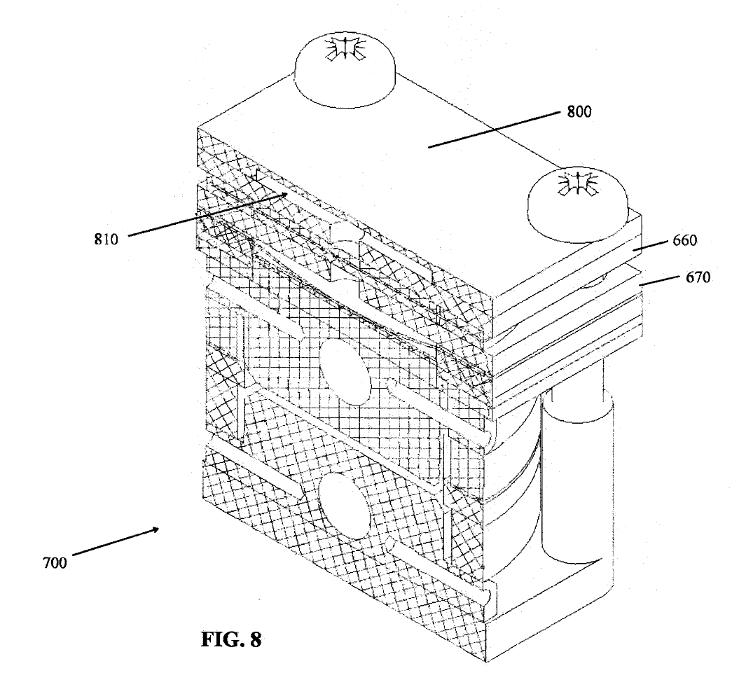

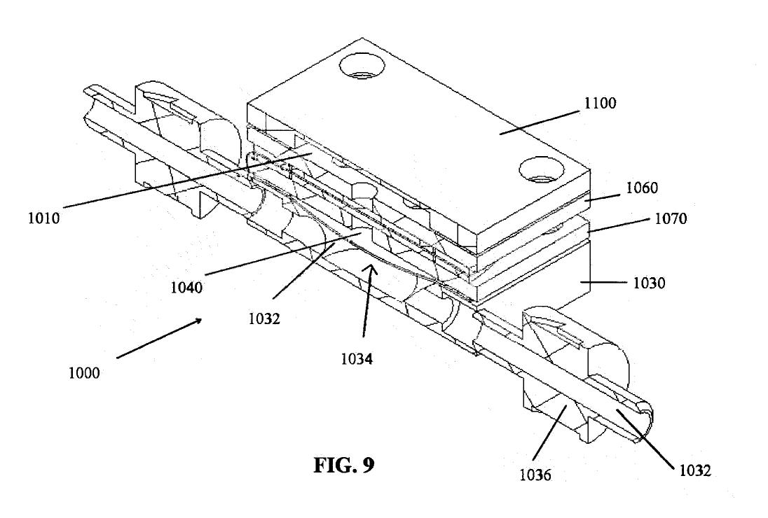

FIGS. 9-10 depict an electrochemically actuated valve system 1000 which includes a cap plate 1100 connected to a compression plate 1060, and the cap plate may be an outermost portion of system 1000. A gas storage cavity 1010 may receive gas generated by a membrane electrode assembly 1020 (e.g., by electrolysis) located between compression plate 1060 and compression plate 1070. Cavity 1010 may be bounded and defined by interior surfaces (not shown and similar to interior surfaces 115) of plate 1100 and an outside surface (not shown and similar to outside surface 62) of compression plate 1060. A seal 1035 may be received in a cavity (not shown and similar to cavity 122) of cap plate 1100 and may inhibit movement of gas (e.g., hydrogen or oxygen) from cavity 1010 toward the surrounding ambient environment.

A diaphragm 1040 is located on an opposite side of the MEA relative to cap plate 1100. An interior (not shown and similar to interior 145) of diaphragm 1040 between diaphragm 1040 and compression plate 1070 may receive a gas (e.g., hydrogen or oxygen) generated by the membrane electrode assembly (e.g., by electrolysis). A seal 1055 between diaphragm 1040 and compression plate 1070 may inhibit movement of a gas (e.g., hydrogen or oxygen) and/or water toward the surrounding ambient environment. Diaphragm 1040 may be flexible and movable in response to a change in an amount of gas in the interior thereof. Actuation chamber plate 1030 may include an a cavity 1034 into which diaphragm 1040 may extend in response to increase in an amount of gas in interior 1045, and the corresponding increase in pressure. Cavity 1034 may be open to allow gas or liquid flow therethrough along with receiving the diaphragm 1040 as it expands and contracts. As the diaphragm moves into cavity 1034 that has a fluid flowing in it the pressure drop of the fluid changes. In this way the valve is a variable pressure drop valve capable of regulating flow from fully open to fully closed off. Alternatively, a flexible tube (not shown) may be received in cavity 1034 and diaphragm 1040 may act on such a tube to regulate flow through the tube and plate 1030. In a further example, such a flexible tube may be received in cavity 1034 and diaphragm 1040 may be absent such that gas generated may act directly on such a flexible tube to regulate the flow through such tube.

Actuation chamber plate 1030 may also include a conduit 1032 or tube therethrough which may receive a flow of gas or liquid to be controlled or regulated by valve system 1000. For example, a movement of diaphragm 1040 caused by an increase in the amount of gas in the interior may control a flow of fluid through conduit 1032. Diaphragm 1040 may be completely cover openings 1033 through plate 1030 to stop flow through plate 1030. Alternately, diaphragm 1040 may partially cover such openings or just constrict the passage to the opening(s) to selectively regulate flow through plate 1030 at a particular flow level. Diaphragm 1040 may be extended (e.g., via electrolysis) or retracted (e.g., via reverse electrolysis) to regulate (e.g., regulated by a controller) such flow through plate 1030. As depicted in FIGS. 9-10, conduit 1032 may include connecting portions 1036 insertable into openings 1033 to form conduit 1032.

Further, plate 1030 may include any number of tubes or passages that may be regulated (e.g., completely or partially collapsed to regulate flow) by the extension and retraction of diaphragm 1040 driven by gas pressure in the interior of diaphragm 1040. Further, multiple systems 1000 may regulate the flow of fluid through plate 1030 or multiple plates 1030. In one example, system 1000 may be utilized to regulate the flow of air to two fuel cells being supplied from a single air source/ pump. In such an application multiple systems 1000 may be placed downstream of a point where the air flow splits and extends into multiple branch lines, each of which extends toward a particular fuel cell. Each of systems 1000 in the corresponding branch line may be independently regulated (e.g., extension or retraction of diaphragm 1040 due to electrolysis controlled by a controller) to regulate a flow to each fuel cell. Further, it will be understood that such a system of regulating the flow of air utilizing multiple systems 1000 may be utilized for applications other than fuel cells that require such regulation of air from a single air source or pump.

In another example, an electrochemical gas generator system may be used to create and control pilot pressure operated devices (e.g., regulators, valves etc.). Typically pilot pressure controlled devices require a large pump to supply pilot pressure. An electrochemical gas generator (e.g., a membrane electrode assembly compressed between two compression plates, such as membrane electrode assembly 20 compressed between compression plate 60 and compression plate 70 via overmolding) having very accurate control may be substituted for such a pump with the resultant advantages of a very small package to create and control a pilot pressure operated device (e.g., a regulator, valve, or actuating member). Also, the electrochemical cell requires very little voltage and power relative to a prior art pump so the electrochemical cell may be supplied from a small battery. The electrochemical cell may be very compact thereby allowing the electrochemical cell to be built right into the regulator or mounted close to where the pressure is needed. Such electrochemical gas generators operating at a location where a pilot pressure is needed has many benefits over the conventional centralized pump with pneumatic lines running to all the locations needing pressure. These advantages include added mobility, substantial size reduction, lower power consumption, and higher reliability.

As described above relative to the figures, an electrochemical cell, including a membrane electrode assembly and compression plates holding such membrane electrode assembly in compression (e.g., by overmolding), may be utilized to generate gas to provide mechanical motion or force to provide actuation for various functions. The gases produced by providing electrical energy to such a membrane electrode assembly may be stored in a storage chamber (e.g., storage chamber 110) or provided to an interior (e.g., interior 145) of a membrane (e.g., membrane 140) which is moveable based on the amount of gas produced by the membrane electrode assembly and received in such an interior. The gases may be recombined to retract such a membrane and form water at the membrane electrode assembly. Methods for purging such gas storage chambers and/or interiors of membranes are also provided to provide repeatability and allow the maintenance of such electrochemical cells providing actuation. Various working fluids (e.g., H₂, O₂, may be utilized to control a size of a diaphragm to provide actuation.

Further, unlike conventional pneumatic actuating members that require a compressor, electrochemical actuating members as described above are self contained requiring only a small current from a low voltage (e.g., less than 2V) source such as a battery. Since they are sealed and contain their own water, they will require little or no outside gases or liquids to operate.

Also, the electrochemical actuating members described require very little hold power (e.g., the power expended to maintain a plunger or actuating member in a particular position) compared to conventional actuation mechanisms such as solenoid actuating members. For example, the only hold power required is to make up for the gas that may diffuse through the membrane or otherwise may leak to the surrounding ambient environment. Such leakage may be limited by utilizing the seals described above.

Although preferred embodiments have been depicted and described in detail herein, it will be apparent to those skilled in the relevant art that various modifications, additions, substitutions and the like can be made without departing from the spirit of the invention and these are therefore considered to be within the scope of the invention as defined in the following claims.

What is claimed is:

1. A heat switch system comprising:
a first surface thermally coupled to at least a portion of an associated component requiring temperature control;
a second surface spaced by a gap relative to said first surface; and
a gas generator coupled to a first chamber;
said first chamber configured to hold a gas generated by said gas generator;
said first chamber comprising a diaphragm configured to deform in response to a an increase in an amount of the gas in said first chamber, wherein a deformation of said diaphragm in response to said increase in said amount of the gas in said first chamber causes movement of at least one of said first surface and said second surface such that said first surface and said second surface move toward each other and heat is transferred from said first surface to said second surface.

2. The system of claim 1 wherein said gas generator comprises a membrane electrode assembly coupled to a source of electrical energy, said membrane electrode assembly comprising a proton-exchange membrane disposed between a first electrode and a second electrode, said gas generator generating the gas in response to an application of electrical energy to said proton-exchange membrane.

3. The system of claim 2 wherein said membrane electrode assembly and said first chamber are sealed to inhibit fluid communication with the surrounding ambient environment.

4. The system of claim 1 further comprising a resilient member disposed to bias said first surface and said second surface away from each other to retain said gap between said first surface and said second surface when heat transfer is minimized between said first surface and said second surface.

5. The system of claim 1 further comprising a heat exchange conduit coupled between the first surface and said component requiring temperature control.

6. The system of claim 5 wherein said heat exchange conduit comprises a heat pipe.

7. The system of claim 1 further comprising a heat exchange conduit coupled between said second surface and a heat source or a heat sink.

8. The system of claim 7 wherein said heat exchange conduit comprises a heat pipe.

9. The system of claim 1 further comprising a heat conducting member coupled between the first surface and said component requiring temperature control.

10. The system of claim 1 further comprising a heat conducting member coupled between said second surface and a heat source or a heat sink.

11. The system of claim 1 wherein said second surface is coupled to the ambient environment or an associated heat sink such that when heat is conducted from said first surface to said second surface, heat is thereafter conducted to the ambient environment or to the associated heat sink.

12. The system of claim 1 wherein said diaphragm is configured to deform in response to a decrease in said amount of the gas such that the first surface and the second surface are spaced apart from each other by the gap.

13. A method for controlling temperature of a component comprising:
thermally coupling the component to a first surface;
spacing a second surface from the first surface by a gap;
generating a gas by a gas generator and receiving the gas in a first chamber;
increasing an amount of the gas in the first chamber to deform a diaphragm in the first chamber to cause movement of at least one of the first surface and the second surface such that the first surface and the second surface move toward each other and heat is transferred from the first surface to the second surface.

14. The method of claim 13 wherein the generating the gas comprises applying electrical energy to a proton-exchange membrane disposed between a first electrode and a second electrode.

15. The method of claim 14 further comprising sealing the membrane electrode assembly and the first chamber to inhibit fluid communication with the surrounding ambient environment.

16. The method of claim 13 further comprising biasing the first surface and the second surface away from each other by a resilient member to retain the gap.

17. The method of claim 13 further comprising decreasing an amount of the gas in the first chamber to deform the diaphragm to cause movement of the at least one of the first surface and the second surface such that the first surface and the second surface move away from each other to minimize heat transfer between said first surface and said second surface.

18. The method of claim 13 further comprising coupling the first surface and the component requiring temperature control to each other via at least one heat exchange conduit.

19. The method of claim 18 wherein said heat exchange conduit comprises a heat pipe

20. The method of claim 13 further comprising coupling the second surface to a heat source or a heat sink via a heat exchange conduit.

21. The method of claim 20 wherein said heat exchange conduit comprises a heat pipe

22. The method of claim 13 further comprising coupling the second surface to the ambient environment such that when heat is conducted from the first surface and the second surface the heat is conducted to the ambient environment.

23. A method for use in monitoring a state of an actuator comprising:
providing a membrane electrode assembly coupled to a source of electrical energy, the membrane electrode assembly comprising a proton-exchange membrane disposed between a first electrode and a second electrode;
applying a voltage to the membrane electrode assembly to deplete a gas in a first chamber on a first side of the membrane and to generate a gas on an opposite side of the membrane into a second chamber;
monitoring an amount of electrical current on the membrane;
determining an amount of the gas in at least one of the first chamber and the second chamber based on the amount of the current.

24. The method of claim 23 further comprising determining an extension state or a retraction state of an actuator based on the amount of gas in the at least one of the first chamber and the second chamber.

25. The method of claim 23 further comprising reversing a polarity of the voltage to cause a generation of the gas into the first chamber and a depletion of the gas in the second chamber.

26. The method of claim 25 further comprising monitoring a second amount of electrical current on the membrane and determining a second amount of the gas in at least one of the first chamber and the second chamber based on the second amount of current.

27. The method of claim 26 further comprising determining a leak rate of the gas out of at least one of the first chamber and the second chamber based on the first amount of the current and the second amount of the current.
